(19) United States
(12) Patent Application Publication
(10) Pub. No.: US 2023/0123347 A1
(43) Pub. Date: Apr. 20, 2023

(54) DRIVER MONITOR SYSTEM ON EDGE DEVICE

(71) Applicant: VINAI ARTIFICIAL INTELLIGENCE APPLICATION AND RESEARCH JOINT STOCK COMPANY, Ha Noi (VN)

(72) Inventors: The De VU, Ha Noi (VN); Van Tuong NGUYEN, Ha Noi (VN); Truong Trung Tin NGUYEN, Ha Noi (VN); Viet Thanh Dat NGUYEN, Ha Noi (VN); Anh Pha NGUYEN, Ha Noi (VN); Duc Toan BUI, Ha Noi (VN); Hai Hung BUI, Ha Noi (VN)

(21) Appl. No.: 17/894,960

(22) Filed: Aug. 24, 2022

(30) Foreign Application Priority Data
Oct. 14, 2021 (VN) 1-2021-06480

(51) Int. Cl. G06N 20/00

(52) U.S. Cl. CPC G06N 20/00

(57) ABSTRACT

A driver monitor system includes an image data acquiring module configured to acquire a plurality of image data from a data collection module; a training module configured to train a plurality of teacher models to obtain a plurality of feature groups using the plurality of image data, and transfer a plurality of pieces of knowledge obtained from the plurality of feature groups to a plurality of student models, respectively; and at least one edge device comprising the plurality of student models configured to use a pipeline design pattern with multiple threads to make a warning.

### CROSS-REFERENCE TO RELATED APPLICATION

The preapplication claims priority from Vietnamese Application No. 1-2021-06480 filed on Oct. 14, 2021, which is incorporated herein by reference in its entirety.

### TECHNICAL FIELD

Embodiments of the present invention relate to a driver monitor system on an edge device.

### RELATED ART

Techniques have been developed recently for monitoring the state of a driver to prevent automobile traffic accidents caused by falling asleep, sudden changes in physical condition, and the like. There has also been an acceleration in trends toward automatic driving technology in automobiles. In automatic driving, the steering of the automobile is controlled by a system, but given that situations may arise in which the driver needs to take control of driving from the system, it is necessary during automatic driving to monitor whether or not the driver is able to perform driving operations.

For this purpose, the application of computer vision, especially the rapidly developing deep learning technology, is being considered, but there are problems that the computing cost is high and it is difficult to deploy multiple models on edge devices.

### SUMMARY

The present invention is to provide a driver monitor system capable of applying a deep learning model and executing it in real time on an edge device.

One aspect of the present invention provides a driver monitor system comprising an image data acquiring module configured to acquire a plurality of image data from a data collection module; a training module configured to train a plurality of teacher models to obtain a plurality of feature groups using the plurality of image data, and transfer a plurality of pieces of knowledge obtained from the plurality of feature groups to a plurality of student models, respectively; and at least one edge device comprising the plurality of student models configured to use a pipeline design pattern with multiple threads to make a warning.

According to an embodiment of the invention, the plurality of student models receive the transferred knowledge using the knowledge distillation technique.

According to an embodiment of the invention, the plurality of student models perform inference based on the transferred knowledge to get a vision-based information including information on confidence of landmarker points, usage of a sunglass and a phone, information on an eye-gaze and an eye-state, and information of a mouth state, and make a warning based on the vision-based information and a car-based information.

According to an embodiment of the invention, the plurality of image data includes at least one of a facial image data, a cropped face image data, a cropped eye image data, a hand image data a phone image data, and a sunglass image data, and wherein the plurality of teacher models include a first teacher model, a second teacher model and a third teacher model.

According to an embodiment of the invention, the plurality of feature groups include a first feature group, a second feature group and a third feature group, wherein the first teacher model is trained based on the facial image data, the hand image data, the phone image data and the sunglass image data to acquire the first feature group including a face detection feature, a hand detection feature, a phone detection feature, and a sunglass detection feature.

According to an embodiment of the invention, the second teacher model is trained based on the cropped face image data to acquire the second feature group including a plurality of facial landmarks.

According to an embodiment of the invention, the third teacher model is trained based on the cropped eye image data to acquire the third feature group including an eye-state detection feature and an eye-gaze detection feature.

According to an embodiment of the invention, the plurality of pieces of knowledge include a first knowledge, a second knowledge and a third knowledge, wherein the plurality of student models include a first student model trained based on the first knowledge transferred from the first teacher model; a second student model trained based on the second knowledge transferred from the second teacher model; and a third student model trained based on the third knowledge transferred from the third teacher model; wherein the knowledge transferring to the first, second, and third student models are executed using the knowledge distillation technique.

According to an embodiment of the invention, the multiple threads on the edge device comprises: a first thread configured to preprocess image frames input from at least one camera; a second thread configured to do inference a face and a hand of a driver, a phone, and a sunglass from the image frames preprocessed by the first thread to get a plurality of bounding boxes corresponding to the face, the hand, the phone, and the sunglass; a third thread configured to do a first inference on the plurality of bounding boxes to get a first output; a fourth thread configured to do a second inference on the first output to get a second output; a fifth thread configured to do a third inference on the second output to get a third output; and a sixth thread configured to make a warning decision based on a vision-based information and a car-based information, wherein the vision-based information includes the first to third outputs.

According to an embodiment of the invention, each of the first to sixth threads is simultaneously processed in communication with each other.

According to an embodiment of the invention, the image frames include one of RGB format, BGR format, RGBA format or YUV format.

According to an embodiment of the invention, the BGR format, the RGBA format and the YUV format are converted to RGB format by the first thread; and wherein the image frames are also converted to “ncnn” matrix.

According to an embodiment of the invention, the plurality of image data includes a facial image data and a hand image data of a driver, a phone image data, and a sunglass image data, and wherein the plurality of bounding boxes include a face bounding box corresponding to the facial image data, a hand bounding box corresponding to the hand image data, a phone bounding box corresponding to the phone image data, and a sunglass bounding box corresponding to the sunglass image data.

According to an embodiment of the invention, the second thread generates a first event indicating that the driver wears the sunglass if the sunglass image data is detected in the face bounding box, and a second event indicating that the driver uses the phone if the hand and phone image data are detected in the face bounding box.

According to an embodiment of the invention, the third thread do the first inference on a cropped face derived from the face bounding box to get the first output, wherein the first output is an intermediate feature of landmark.

According to an embodiment of the invention, the fourth thread performs the second inference on the first output to get a plurality of facial landmarks, and estimates a head-pose and a mouth state and crops eye patches of the driver based on the plurality of facial landmarks, wherein the second output includes the head-pose, mouth state, and cropped eye patches.

According to an embodiment of the invention, the fifth thread performs the third inference on the head-pose and the cropped eye patches to get the eye-gaze and eye-state, and wherein the third output includes the eye-gaze and eye-state.

According to an embodiment of the invention, the vision-based information includes information on confidence of landmarker points, usage of the sunglass and the phone, information on the eye-gaze and eye-state, and information of the mouth state, and wherein the car-based information includes a speed, a steering wheel angle, and turn left/right signal generated during a driving of the car.

According to an embodiment of the invention, the warning decision is decided according to one of following modes: a first mode indicating a sleeping level 1 or 2 in which the driver's eyes are closed continuously in 2.5 seconds or 5 seconds respectively; a second mode indicating a distraction level 1 or 2 in which the driver's eyes are off a road or the head-pose deviates 30 degrees from a normal pose in 2.5 seconds or 5 seconds, respectively; a third mode indicating a drowsiness level 1 or 2 in which a total time the driver's eyes are closed is 7 to 9 seconds or 9 seconds or more in 1 minute, respectively; a fourth mode indicating that a total time of the driver yawning duration is 18 seconds or more in 3 minutes; and a fifth mode indicating a dangerous behavior in which the driver uses the phone.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a block diagram illustrating a driver monitor system according to embodiment of the present invention;

FIG. 2 is a diagram illustrating a first training module of the training system shown in FIG. 1;

FIG. 3 is a diagram illustrating a second training module of the training system shown in FIG. 1;

FIG. 4 is a diagram illustrating a third training module of the training system shown in FIG. 1;

FIG. 5 is a diagram illustrating a knowledge distillation technique applied to the embodiment of the present invention;

FIG. 6 is a diagram illustrating the edge device comprising the plurality of student models shown in FIG. 1;

FIG. 7 is a diagram illustrating a method for training multi-tasks in a first teacher model;

FIG. 8 is a diagram illustrating a method for training multi-tasks in a second teacher model.

FIG. 9 is a diagram illustrating a method for training multi-tasks in a third teacher model.

### DETAILED DESCRIPTION

Hereinafter, embodiments of the present invention will be described in detail with reference to the accompanying drawings.

However, the technical idea of the present invention is not limited to some embodiments set forth herein and may be embodied in many different forms, and one or more components of these embodiments may be selectively combined or substituted within the scope of the present invention.

All terms (including technical and scientific terms) used in embodiments of the present invention have the same meaning as commonly understood by those of ordinary skill in the art to which the present invention pertains, unless otherwise defined. Terms, such as those defined in commonly-used dictionaries, should be interpreted as having a meaning in the context of the relevant art.

In addition, the terms used in embodiments of the present invention are for the purpose of describing embodiments only and are not intended to be limiting of the present invention.

As used herein, singular forms are intended to include plural forms as well, unless the context clearly indicates otherwise. Expressions such as “at least one (or one or more) of A, B and C” should be understood to include one or more of all possible combinations of A, B, and C.

In addition, terms such as first, second, A, B, (a), and (b) may be used to describe components of embodiments of the present invention.

These terms are only for distinguishing a component from other components and thus the nature, sequence, order, etc. of the components are not limited by these terms.

When one component is referred to as being “coupled to,” “combined with,” or “connected to” another component, it should be understood that the component is directly coupled to, combined with or connected to the other component or is coupled to, combined with or connected to the other component via another component therebetween.

When one component is referred to as being formed or disposed “on (above) or below (under)” another component, it should be understood that the two components are in direct contact with each other or one or more components are formed or disposed between the two components. In addition, it should be understood that the terms “on (above) or below (under)” encompass not only an upward direction but also a downward direction with respect to one component.

Hereinafter, embodiments will be described in detail with reference to the accompanying drawings, and the same or corresponding components will be assigned the same reference numerals even in different drawings and a description thereof will not be redundantly described herein.

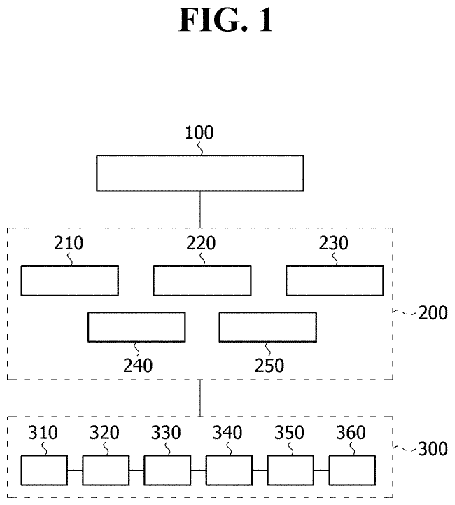

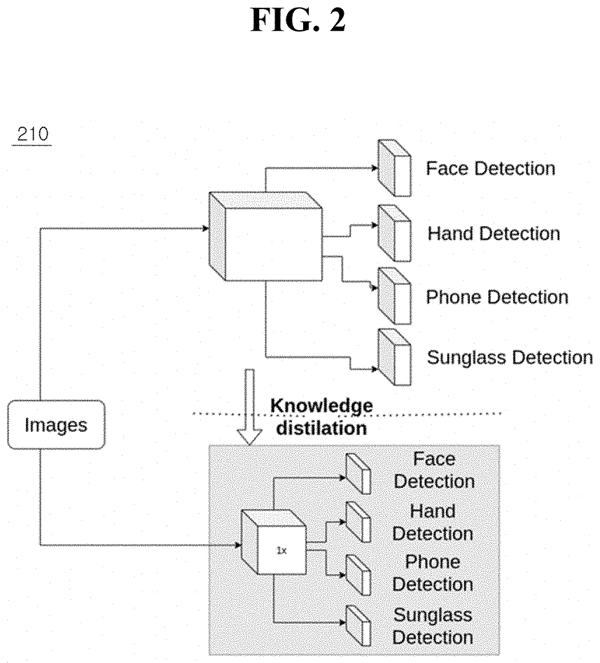

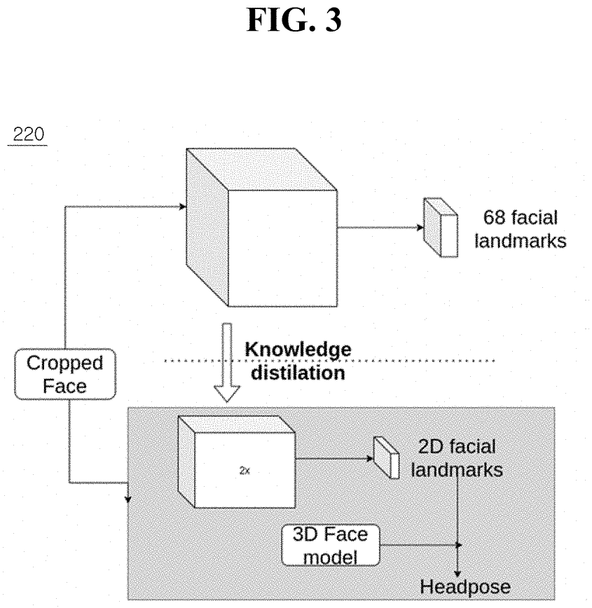

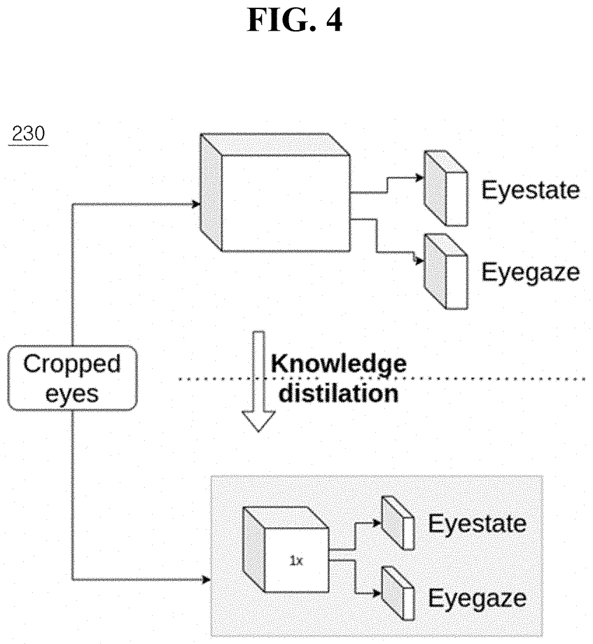

FIG. 1 is a block diagram illustrating a driver monitor system according to embodiment of the present invention. FIG. 2 is a diagram illustrating a first training module of the training system shown in FIG. 1. FIG. 3 is a diagram illustrating a second training module of the training system shown in FIG. 1. FIG. 4 is a diagram illustrating a third training module of the training system shown in FIG. 1.

Referring to FIG. 1, the driver monitor system comprises a data collection module 100, a training module 200 and an edge device 300.

The data collection module 100 includes at least one camera (not shown) and an image data acquiring unit 110. The camera captures images having RGB format, BGR format, RGBA format or YUV format. The image data acquiring unit 110 acquires a plurality of image data from the camera. The plurality of image data includes at least one of a facial image data, a cropped face image data, a cropped eye image data, a hand image data, a phone image data, a sunglass image data and so on.

The training system 200 trains a plurality of teacher models including a plurality of feature groups to transfer the feature groups to a plurality of student model by using a knowledge distillation technique shown in FIGS. 1 to 4.

As an example, the plurality of teacher models includes a first training model 210, a second training model 220, and a third training model 230.

The first training model 210 includes a first feature group obtained using the plurality of image data. The first training model 210 is trained based on the facial image data, the hand image data, the phone image data and the sunglass image data to acquire the first feature group. The first feature group includes a face detection feature, a hand detection feature, a phone detection feature, a sunglass detection feature, and so on.

The second training model 220 includes a second feature group obtained using the cropped face image data. The second training model 220 is trained based on the cropped face image data. The second feature group includes a plurality of facial landmarks.

The third training model 230 includes a second feature group obtained using the cropped face image data. The third training model 230 is trained based on the cropped eye image data. The third feature group includes an eye-state detection feature and an eye-gaze detection feature.

In the knowledge distillation technique, a plurality teacher models 240 and a plurality of student models 250 are used. The knowledge distillation technique uses a multitask-learning which groups highly related features into one model. For example, the face detection, the hand detection, the phone detection and the sunglass detection are grouped into one model and the eye-gaze and the eye-state are grouped into another one model.

The plurality teacher models 240 include a first teacher model, a second teacher model and a third teacher model.

The first teacher model is trained based on the facial image data, the hand image data, the phone image data and the sunglass image data to acquire the first feature group including a face detection feature, a hand detection feature, a phone detection feature, and a sunglass detection feature.

The second teacher model is trained based on the cropped face image data to acquire the second feature group including the plurality of facial landmarks.

The third teacher model is trained based on the cropped eye image data to acquire the third feature group including the eye-state detection feature and the eye-gaze detection feature.

The plurality of student models 250 transfer a plurality of pieces of knowledge obtained from the plurality of feature groups to a plurality of student models, respectively.

The plurality of pieces of knowledge include a first knowledge, a second knowledge and a third knowledge. The first knowledge is obtained from the first feature group. The second knowledge is obtained from the second feature group. The third knowledge is obtained from the third feature group.

The plurality of student models 250 include a first student model, a second student model and a third student model.

The first student model is trained based on the first knowledge transferred from the first teacher model, the second student model is trained based on the second knowledge transferred from the second teacher model, and the third student model is trained based on the third knowledge transferred from the third teacher model.

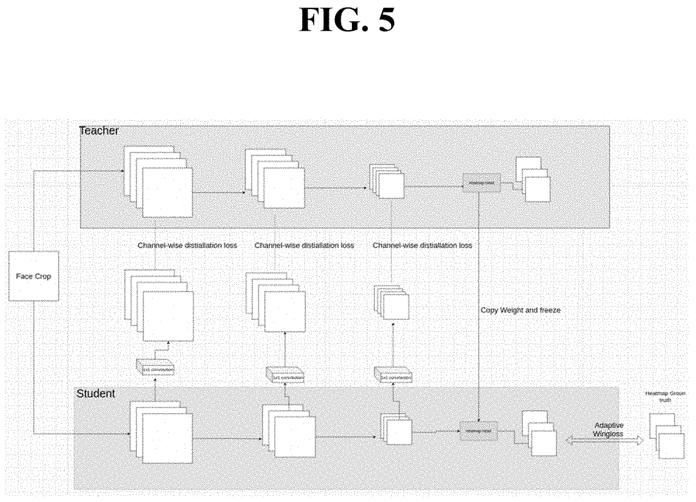

Hereinafter, knowledge distillation will be described with reference to FIG. 5. FIG. 5 is a diagram illustrating a knowledge distillation technique applied to the embodiment of the present invention.

Knowledge distillation is the process of transferring knowledge from a large model to a smaller one. While large models (such as very deep neural networks or ensembles of many models) have higher knowledge capacity than small models, this capacity might not be fully utilized. It can be computationally just as expensive to evaluate a model even if it utilizes little of its knowledge capacity. Knowledge distillation transfers knowledge from a large model to a smaller model without loss of validity.

The knowledge distillation uses the idea of “Channel-Wise Distillation” founded in document “Channel Distillation: Channel-Wise Attention for Knowledge Distillation” by Zhou et al., and re-use the heatmap head's weights of the teacher to the student.

The teacher model is mobilev21.4x, student model is small mobile v20.25x. Because they will have a different number of feature maps in each block, 1×1 convolution layers is used to map the number of feature maps of students equals to those of teachers.

Channel-wise loss between blocks of teacher models and that of student models after 1×1 convolution, is calculated. It will force the feature map of student similar to that of the teacher, so the student will have better a representation like the teacher.

Weights of the heatmap head of the teacher model are copied to that of the student. Then the heatmap-head of the student model is “frozen”. It will force the model to more focus on learning the representation in feature maps.

Besides channel-wise distillation loss, adaptive wing loss for predicted heatmap and ground truth heatmaps is used.

The total loss=alpha*channel-wise loss+adaptive wingloss. By experiment, alpha=4 is chosen.

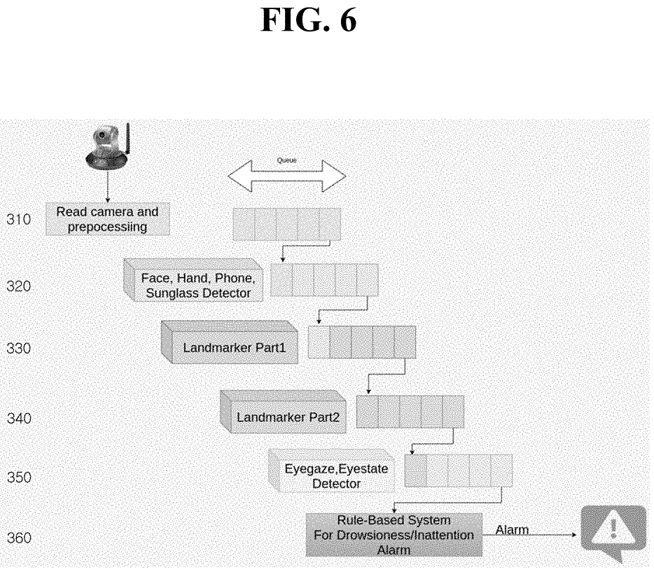

Hereinafter, the edge device 300 will be described with reference to FIG. 6. FIG. 6 is a diagram illustrating the edge device 300 comprising the plurality of student models shown in FIG. 1.

The edge device 300 is designed to take advantage of multithread power. By doing that, a preprocessing time of overall system will equal to the biggest component (or model) in the system.

Referring to FIG. 6, the edge device 300 includes a first thread 310, a second thread 320, a third thread 330, a fourth thread 340, a fifth thread 350 and a sixth thread 360. The downstream thread may take outputs of the upstream threads as input for inference.

According to an embodiment of the invention, the first thread preprocesses image frames input from at least one camera. The image frames include one of RGB format, BGR format, RGBA format or YUV format. The BGR format, the RGBA format and the YUV format may be converted to RGB format by the first thread. The plurality of image data includes a facial image data and a hand image data of a driver, a phone image data, and a sunglass image data.

The second thread performs inference a face and a hand of a driver, a phone, and a sunglass from the image frames preprocessed by the first thread to get a plurality of bounding boxes corresponding to the face, the hand, the phone, and the sunglass (the plurality of image data).

The plurality of bounding boxes include a face bounding box corresponding to the facial image data, a hand bounding box corresponding to the hand image data, a phone bounding box corresponding to the phone image data, and a sunglass bounding box corresponding to the sunglass image data. Based on the sunglass bounding box, the second thread may generate information on sunglass usage which is the sunglass probability indicating how confidence the driver is wearing sunglass.

The second thread generates a first event indicating that the driver wears the sunglass if the sunglass image data is detected in the face bounding box, and a second event indicating that the driver uses the phone if the hand and phone image data are detected in the face bounding box.

The third thread performs a first inference on the plurality of bounding boxes to get a first output. For example, the third thread may perform the first inference on a cropped face derived from the face bounding box to get the first output, wherein the first output is an intermediate feature of landmark. Other information such as information on sunglass usage and the preprocessed image may also be fed to the third thread.

The fourth thread performs a second inference on the first output to get a second output. According to an embodiment of the invention, the second output may include a head-pose, a mouth state, and cropped eye patches of the driver. For example, the fourth thread performs the second inference on the first output to get a plurality of facial landmarks. Preferably, the plurality of facial landmarks is 68 2D facial landmarks. Based on the plurality of facial landmarks, the fourth thread estimates a head-pose, a mouth state, and crops eye patches of the driver.

The fifth thread performs a third inference on the second output to get a third output. For example, the third output includes the eye-gaze and eye-state.

The sixth thread makes a warning decision based on a vision-based information and a car-based information, wherein the vision-based information includes the first to third outputs. The vision-based information may include information on confidence of landmarker points, usage of the sunglass and the phone, information on the eye-gaze and eye-state, and information on the mouth state. The confidence of landmark points indicates whether eyes or mouth occluded. If they are not occluded, then they can be used to calculate information like eye closure, yawning frequency, etc. The information of the mouth state may indicate yawning frequency. The car-based information includes a speed, a steering wheel angle, and turn left/right signal generated during a driving of the car. The speed can be used to adjust the warning decision (e.g in the highway with high speed, the alarm should be more aggressive than in the city with low speed). The steering wheel angle or turn left/right signal are used to disable the distraction warning (e.g. when the turn left/right signal on, the eyes of the driver seem look off the road more often, may be they look at the mirror to switch lane, etc., it should not be warned as distraction.)

The warning decision is decided according to one of first to six modes.

The first mode indicates a sleeping level 1 or 2 in which the driver's eyes are closed continuously in 2.5 seconds or 5 seconds respectively.

The second mode indicates a distraction level 1 or 2 in which the driver's eyes are off a road or the head-pose deviates 30 degrees from a normal pose in 2.5 seconds or 5 seconds, respectively.

The third mode indicates a drowsiness level 1 or 2 in which a total time the driver's eyes are closed is 7 to 9 seconds or 9 seconds or more in 1 minute, respectively.

The fourth mode indicates that a total time of the driver yawning duration is 18 seconds or more in 3 minutes.

The fifth mode indicates a dangerous behavior in which the driver uses the phone.

In one at a time, there is only one kind of warning. For example, if the driver is detected as drowsy and at the same time takes his eyes off the road, a sleep alert is selected without warning of distraction. Because a sleeping is much more dangerous compared to the distraction.

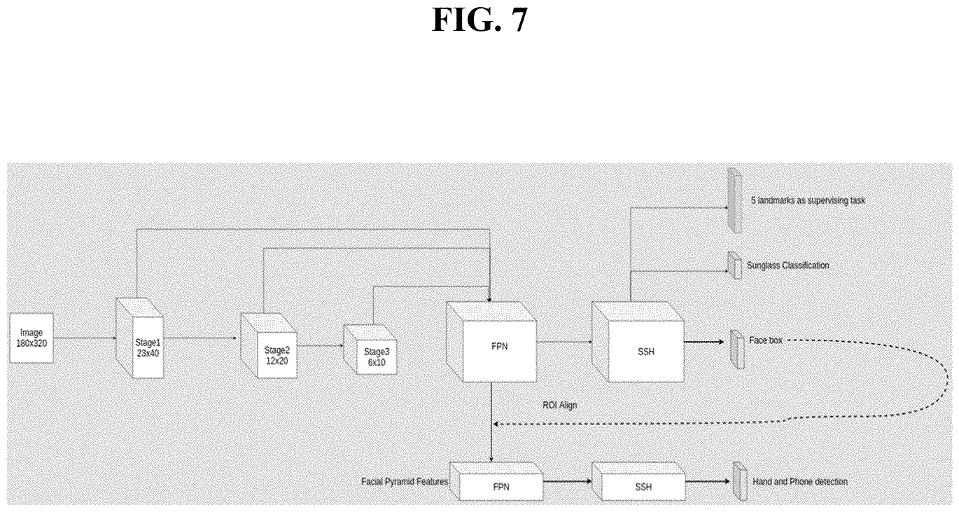

Hereinafter, a method for training each of the first to third teacher models in the driver monitor system will be more detailed described with reference to FIGS. 7 to 9.

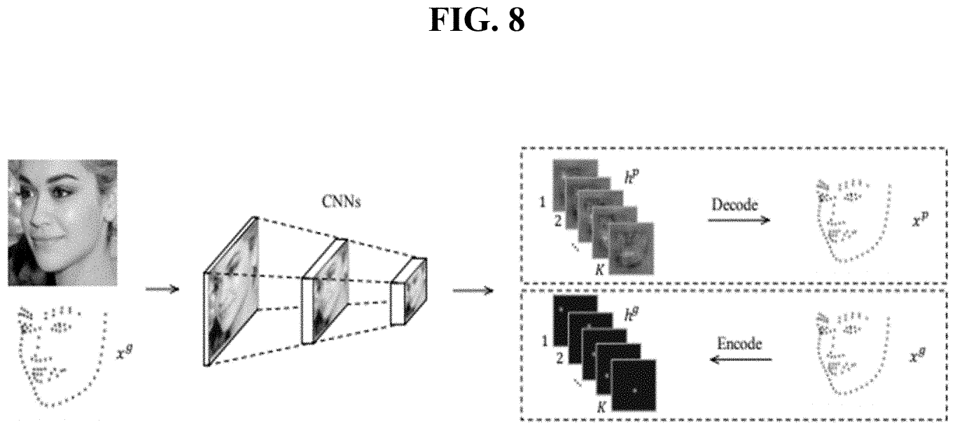

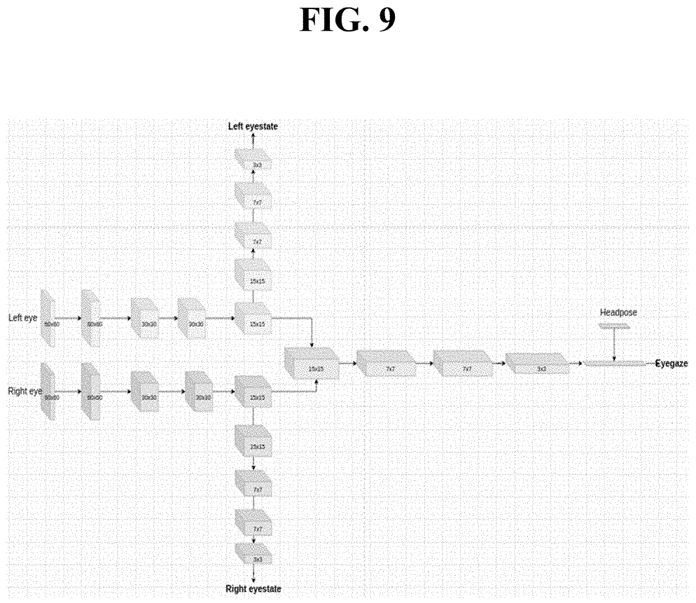

FIG. 7 is a diagram illustrating a method for training multi-tasks in a first teacher model. FIG. 8 is a diagram illustrating a method for training multi-tasks in a second teacher model. FIG. 9 is a diagram illustrating a method for training multi-tasks in a third teacher model.

The models are designed by grouping “similar” tasks together. Basically “Hard parameter sharing” is used, there is one main backbone used to extract share features and separate branches for specific tasks. Each of the tasks might have different loss functions. The loss functions are chosen so that their value ranges are the same among all tasks (e.g., in [0,1] range). This will help the model not bias to any task.

Referring to FIG. 7, the first teacher model is trained based on RetinaFace. There are some differences. Four tasks including model, architecture, hyper-parameters, and loss function v.v. are trained. In a first teacher model, mobilev2 is firstly used, and then a sunglass classification branch is added together with box regression branch. Next, ROI aligns to crop the facial features, and re-use it to start another multi-object detection branch for phone and hand.

WiderFace and self-collected data may be used as data. A loss in the first teacher model is the same as RetinaFace. There may be Multi-box loss for detection branches (face, phone, hand) and cross entropy for sunglass classification branch and smooth-L1 for supervising landmark branch.

The training procedure is as follows:
(1) A pre-trained backbone mobilev2 from Imagenet is used to leverage learned features.
(2) Only the face and sunglass branch first are trained until the model get to the certain accuracy in face box detection branch.
(3) Hand and phone branches are added, and they are trained together with the face and sunglass branches.
(4) With a small batch size, one batch for face and sunglass and another batch for hand and phone are trained and keep going. By doing that, it is possible to prevent a model bias of all tasks.

Referring to FIG. 8, the second teacher model is trained based on SOTA work “Heatmap Regression via Randomized Rounding”. There are a few changes.

In the second teacher model, firstly, MobileNetV21.4x is used instead of HRNet. Because it is faster for training and do experiments. Secondly, mobilev2 architecture for the student model is also used. It is more straight-forward and easier to do knowledge distillation with a similar kind of backbone (e.g MobileV2 1.4x and MobileV2 0.25x).

The images are taken from a paper which was proposed Baosheng Yu and Dacheng Tao, and entitled “Heatmap Regression via Randomized Rounding” founded in https://arxiv.org/abs/2009.00225.

In the second teacher model, some public dataset (like 300W, 300VW, 300W-LP. etc) and self-collected datasets which are more diverse in term of lighting condition, pose (especially high/low pitch), expression and camera noise are trained.

WiderFace and self-collected data may be used as data. “Adaptive Wingloss” which is proved as an effective in heatmap-based regression approach are used as a loss function. The “Adaptive Wingloss” is found in https://arxiv.org/abs/1904.07399.

The training procedure is based on the idea of “Curriculum Leanring” founded in https://arxiv.org/pdf/1904.03626.pdf, in which model on the easier datasets is firstly trained, and then more difficult datasets are added. By doing that, the model will learn faster and more robust.

The training procedure is as follows:
(1) The “easiser” dataset like 300VW, 300W first for some epochs is firstly trained. It contains more frontal faces and less large pose faces.
(2) More difficult dataset like 300W-LP (Large Pose) and self-collect dataset including large pose and more emotions (smile, yawning, angry, etc) are added.
(3) The shuffled data are trained so that the model is not biased to any kind of data.

Referring to FIG. 9, in the third teacher model, “Inverted Residual Blocks” (proposed in MobileNetV2) founded in https://arxiv.org/abs/1801.04381 are used as a primary block in the model

The left eye and the right eye will go through 4 inverted residual blocks to extract intermediate features. Those intermediate features of the left eye and right eye will either be concatenated together for the eye-gaze branch, or go independently for separate eye-state branches.

Using two eyes in the network instead of one eye will help the model in the case when there is one eye occluded then the eye-gaze can be inferred by another visible eye.

At the very end of the eye-gaze branch, head-pose information is added as an important cue for eye-gaze estimation. It will help the model estimate the eye-gaze correctly even when the eyes are mostly occluded. The reason behind that is the eye-gaze can be inferred mathematically by the head-pose assuming the eyes looks straight (i.e., the iris is at the center of the eye).

This work in Section 6 found in https://sci-hub.mksa.top/10.1145/2897824.2925947 shows how head-pose is highly correlated to the eye-gaze.

Losses include cross-entropy for eye-state and angular loss for eye-gaze. It is ensured that the range of those losses are equal (i.e., in 0-1 range) so that the model does not bias in any task.

Both synthesized data like UnityEye dataset and self-collected data may be used as data.

The training procedure may be kept by using the curriculum training strategy. The training procedure is as follows:
(1) Synthesis datasets are trained firstly for some epoch.
(2) The synthesis datasets are replaced with the self-collected datasets which are much more difficult and more diverse in terms of lighting condition, camera devices (RGB/IR), wearing eyeglass/sunglass with 4 categories (1-4), wearing facemask, etc.
(3) Because there are two kinds of different datasets, which include one for eye-state and another one for eye-gaze. So each batch is trained by different dataset with a small batch size to ensure the model not bias to one task.

The term ‘unit’ and ‘module’ as used herein refers to software or a hardware component, such as a field-programmable gate array (FPGA) or an application-specific integrated circuit (ASIC), which performs certain functions. However, the term ‘unit’ is not limited to software or hardware. The term ‘unit’ may be configured to be stored in an addressable storage medium or to reproduce one or more processors. Thus, the term ‘unit’ may include, for example, components, such as software components, object-oriented software components, class components, and task components, processes, functions, attributes, procedures, subroutines, segments of program code, drivers, firmware, microcode, a circuit, data, database, data structures, tables, arrays, and parameters. Components and functions provided in ‘units’ may be combined into a smaller number of components and “units” or may be divided into sub-components and ‘sub-units’. In addition, the components and ‘units’ may be implemented to execute one or more CPUs in a device or a secure multimedia card.

The present invention can be achieved by computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present invention should be determined by reasonable analysis of the claims and all changes within an equivalent range of the present invention is included in the scope of the present invention.

While embodiments of the present invention have been described above, it will be apparent to those of ordinary skill in the art that various modifications and changes may be made therein without departing from the spirit and scope of the present invention described in the following claims.

What is claimed is:

1. A driver monitor system comprising:
an image data acquiring module configured to acquire a plurality of image data from a data collection module;
a training module configured to train a plurality of teacher models to obtain a plurality of feature groups using the plurality of image data, and transfer a plurality of pieces of knowledge obtained from the plurality of feature groups to a plurality of student models, respectively; and
at least one edge device comprising the plurality of student models configured to use a pipeline design pattern with multiple threads to make a warning.

2. The system of claim 1, wherein the plurality of student models receive the transferred knowledge using the knowledge distillation technique.

3. The system of claim 2, wherein the plurality of student models perform inference based on the transferred knowledge to get a vision-based information including information on confidence of landmarker points, usage of a sunglass and a phone, information on an eye-gaze and an eye-state, and information of a mouth state, and make a warning based on the vision-based information and a car-based information.

4. The system of claim 3, wherein the plurality of image data includes at least one of a facial image data, a cropped face image data, a cropped eye image data, a hand image data, a phone image data, and a sunglass image data, and
wherein the plurality of teacher models include a first teacher model, a second teacher model and a third teacher model.

5. The system of claim 4, wherein the plurality of feature groups include a first feature group, a second feature group and a third feature group, and
wherein the first teacher model is trained based on the facial image data, the hand image data, the phone image data and the sunglass image data to acquire the first feature group including a face detection feature, a hand detection feature, a phone detection feature, and a sunglass detection feature.

6. The system of claim 5, wherein the second teacher model is trained based on the cropped face image data to acquire the second feature group including a plurality of facial landmarks.

7. The system of claim 6, wherein the third teacher model is trained based on the cropped eye image data to acquire the third feature group including an eye-state detection feature and an eye-gaze detection feature.

8. The system of claim 7, wherein the plurality of pieces of knowledge include a first knowledge, a second knowledge and a third knowledge,
wherein the plurality of student models include:
a first student model trained based on the first knowledge transferred from the first teacher model;
a second student model trained based on the second knowledge transferred from the second teacher model; and
a third student model trained based on the third knowledge transferred from the third teacher model, and
wherein the knowledge transferring to the first, second, and third student models are executed using the knowledge distillation technique.

9. The system of claim 1, wherein the multiple threads on the edge device comprise:
a first thread configured to preprocess image frames input from at least one camera;
a second thread configured to do inference a face and a hand of a driver, a phone, and a sunglass from the image frames preprocessed by the first thread to get a plurality of bounding boxes corresponding to the face, the hand, the phone, and the sunglass;
a third thread configured to do a first inference on the plurality of bounding boxes to get a first output;
a fourth thread configured to do a second inference on the first output to get a second output;
a fifth thread configured to do a third inference on the second output to get a third output; and
a sixth thread configured to make a warning decision based on a vision-based information and a car-based information, wherein the vision-based information includes the first to third outputs.

10. The system of claim 9, wherein each of the first to sixth threads is simultaneously processed in communication with each other.

11. The system of claim 10, wherein the image frames include one of RGB format, BGR format, RGBA format or YUV format.

12. The system of claim 10, wherein the BGR format, the RGBA format and the YUV format are converted to RGB format by the first thread, and
wherein the image frames are also converted to “ncnn” matrix.

13. The system of claim 9, wherein the plurality of image data includes a facial image data and a hand image data of a driver, a phone image data, and a sunglass image data, and
wherein the plurality of bounding boxes includes a face bounding box corresponding to the facial image data, a hand bounding box corresponding to the hand image data, a phone bounding box corresponding to the phone image data, and a sunglass bounding box corresponding to the sunglass image data.

14. The system of claim 13, wherein the second thread generates a first event indicating that the driver wears the sunglass if the sunglass image data is detected in the face bounding box, and a second event indicating that the driver uses the phone if the hand and phone image data are detected in the face bounding box.

15. The system of claim 14, wherein the third thread do the first inference on a cropped face derived from the face bounding box to get the first output, wherein the first output is an intermediate feature of landmark.

16. The system of claim 15, wherein the fourth thread performs the second inference on the first output to get a plurality of facial landmarks, and estimates a head-pose and a mouth state and crops eye patches of the driver based on the plurality of facial landmarks, wherein the second output includes the head-pose, mouth state, and cropped eye patches.

17. The system of claim 16, wherein the fifth thread performs the third inference on the head-pose and the cropped eye patches to get the eye-gaze and eye-state, and
wherein the third output includes the eye-gaze and eye-state.

18. The system of claim 17, wherein the vision-based information includes information on confidence of landmarker points, usage of the sunglass and the phone, information on the eye-gaze and eye-state, and information of the mouth state, and
wherein the car-based information includes a speed, a steering wheel angle, and turn left/right signal generated during a driving of the car.

19. The system of claim 18, wherein the warning decision is decided according to one of following modes:
a first mode indicating a sleeping level 1 or 2 in which the driver's eyes are closed continuously in 2.5 seconds or 5 seconds respectively;
a second mode indicating a distraction level 1 or 2 in which the driver's eyes are off a road or the head-pose deviates 30 degrees from a normal pose in 2.5 seconds or 5 seconds, respectively;
a third mode indicating a drowsiness level 1 or 2 in which a total time the driver's eyes are closed is 7 to 9 seconds or 9 seconds or more in 1 minute, respectively;
a fourth mode indicating that a total time of the driver yawning duration is 18 seconds or more in 3 minutes; and
a fifth mode indicating a dangerous behavior in which the driver uses the phone.
